(19) United States
(12) Patent Application Publication
(10) Pub. No.: US 2005/0273349 A1
(43) Pub. Date: Dec. 8, 2005

(54) System and method for establishing computer warranty costs

(75) Inventors: Scott Sina Abedi, Durham, NC (US); Brian Woodall Killebrew, Raleigh, NC (US); Joseph Nicholas Laltrello, Chapel Hill, NC (US); Alan Ladd Painter, Raleigh, NC (US); Stephen Rutledge, Durham, NC (US); Tin-Lup Wong, Chapel Hill, NC (US)

Correspondence Address: LENOVO (SINGAPORE) PTE. LTD., BUILDING 675, MAIL C-137, 4401 SILICON DRIVE, DURHAM, NC, 27709, US

(73) Assignee: International Business Machines Corporation, Armonk, NY (US)

(21) Appl. No.: 10/863,137

(22) Filed: Jun. 8, 2004

(51) Int. Cl. G06F 17/60

(52) U.S. Cl. 705/1

(57) ABSTRACT

Operating parameters and potentially related malfunctions are gathered from end users of computer systems and used to develop models which can be used to subsequently establish warranty costs for customer computers based on their actual usage.

### FIELD OF THE INVENTION

The present invention relates generally to establishing computer warranty costs.

### BACKGROUND OF THE INVENTION

From time to time end user computer system components can malfunction at rates higher than expected. The present warranty terms associated with these systems are not an accurate reflection of customer usage patterns and these patterns' impact on reliability. Currently, the cost of the warranty is the same for all customers regardless of whether they are a high risk user or a low risk user. Customers who don't put their systems through high usage and abuse unfairly pay for too much of the warranty cost. Similarly, high usage customers are not contributing enough to warranty revenue. Another issue seen with today's leasing methods is that no feedback is provided in terms of the usage a system has undergone in the past one to three years. This invention addresses one or more of the above noted problems.

### SUMMARY OF THE INVENTION

A method includes determining warranty costs based on operating usage. Data is gathered that represents at least one operating parameter of the user computer systems to generate a predictive model of risks associated with the user and system operating parameters. For instance, a customer using a system 8 hours a day, 5 days a week might be at a lower risk of system failure than a customer using a system 24 hours a day, 7 days a week. A system parameter can be anything that affects the system favorably or adversely, such as boot counts, actual use, lifetime temperature, temperature alerts, fan alerts, and other field data metrics. An association is then made between usage patterns and failure rates, and determining an associated risk level.

An associated risk level is determined based on the amount each piece of data is weighted. The data is weighted by being multiplied by its own specific factor. The weights are empirically determined through a process where factors that are found to have more impact on causing warranty problems have higher weights. The weighted data is aggregated and compared against warranty calls to develop a predictive model for predicting impending failures. Subsequently, the data from other users is gathered, weighted, and compared against the model to see if particular users are about to experience a failure.

Similarly, for machines coming off lease, the environmental and usage data is used as input to a neural network that is aimed at determining which systems need to be refurbished. For example, if the field metrics for a given system show a significant amount of temperature alerts, then the weights associated with this factor bias the network to produce a “Require Refurbishing” grade. The new data allows for a tiered pricing scheme in the secondary market based upon the output of the neural network.

Accordingly, a method can include establishing a warranty cost for a user computer at least in part based on operating parameters of the user computer. The non-limiting method may include using information from plural user computers of a given type to establish operating parameter weights, and then establishing the user warranty cost at least in part based on the weights.

In another aspect, a general purpose computer system executes logic that includes receiving first data representing at least one computer system operating parameter and associated computer system malfunction. The logic generates at least one model based on the first data for establishing at least one warranty cost at least in part using the model.

In yet another aspect, a service can include providing, to a vendor of computers, warranty costs of user computers as a function of operating parameters of the user computers.

In still another aspect, a method includes establishing secondary market pricing for computers that are or that have been the subject of leases based at least in part on end of lease operating parameters of the computers.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a flow chart of the present method;

FIGS. 3 and 4 show tables of parameters; and

FIG. 5 is a flow chart of establishing secondary pricing in accordance with present principles.

### DETAILED DESCRIPTION OF THE PREFERRED EMBODIMENT

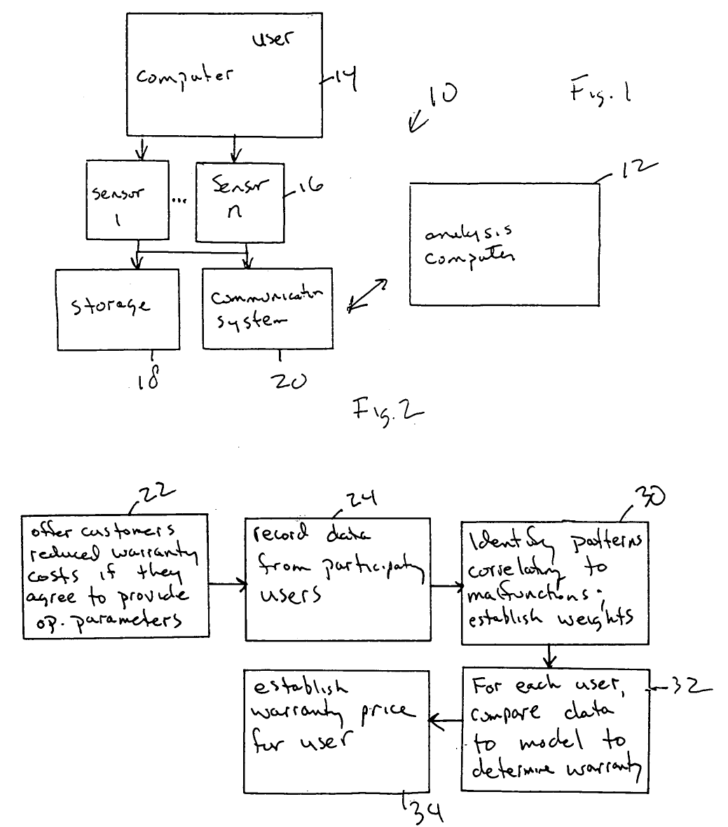

Referring initially to FIG. 1, a computing system is shown, generally designated 10, that includes one or more analysis computers 12 (only a single computer 12 shown for clarity) that undertakes the modelling set forth further below based on input from plural user computers 14 (only a single customer computer shown for clarity). The computers herein can be any suitable computers, e.g., a personal computer or larger (mainframe), a laptop computer, a notebook computer or smaller, etc. For instance, the user computers 14 without limitation can be an IBM Thinkpad® or ThinkCentre™ computer. The analysis computer 12 can be provided by a service provider or it can be provided to a customer with several individual user computers 14. The below-described functions of the analysis computer 12 can be distributed between a vendor server and a customer server if desired.

As shown in FIG. 1, each user computer 14 may include plural sensors 16 that sense operating parameters of the user computer 14. These operating parameters can include environmental characteristics such as computer component temperatures (average and/or peak), airflow, humidity within the user computer 14 components and/or facility, etc. The operating parameters can also include usage patterns, such as the total hours of operation of one or more system components since, e.g., a component was placed into service, number of on-off cycles and/or boot cycles of one or more system components, power consumption of one or more components, both average and, if desired, peak power consumption, and voltages of computer system components, both average and if desired fluctuations. Also, the operating parameters can include application factors such as whether and what type of a screen saver might be invoked, as well as numbers of alarms events such as temperature alerts and fan alerts. Accordingly, the sensors 16 may include, without limitation, power sensors, voltage sensors, temperature sensors, humidity sensors, air flow sensors, application records, alert counters, and timers, and they can be mounted on circuit boards with, e.g., the central processing unit of the user computer 14, within a hard disk drive of the user computer 14, within the power circuit of the user computer 14, and/or on other peripheral computer system components such as monitors, printers, etc.

The user computer 14 may also include storage 18 for storing the outputs of the sensor 16. Also, the user computer 14 can include a communication system 20 such as, without limitation, a modem that can communicate over a network such as the Internet with the analysis computer 12. With this structure, it may be appreciated that the operating parameter data output by the sensors 16 can be stored in the storage 18 for retrieval by personnel associated with the analysis computer 12, and/or it can be sent to the analysis computer 12 over the Internet.

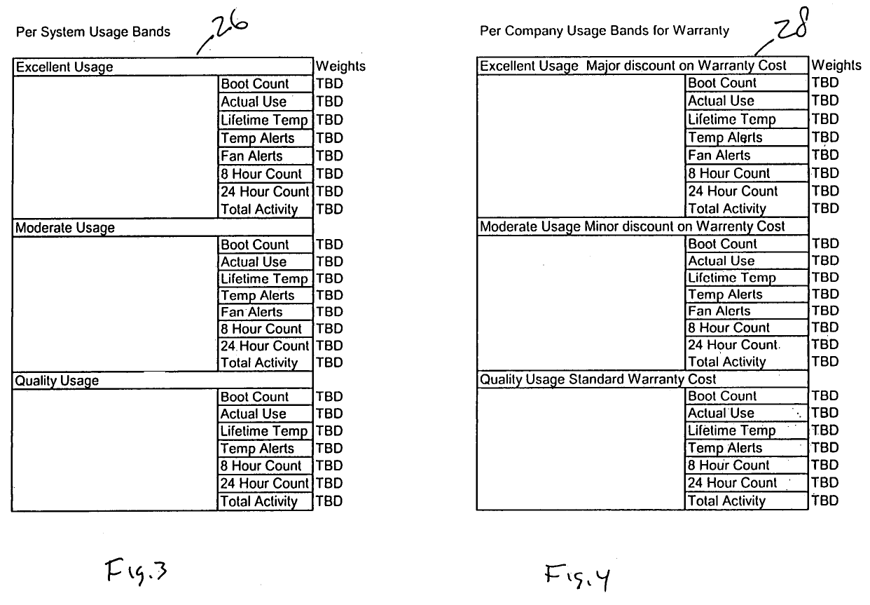

Now referring to FIG. 2, commencing at block 22, if desired customers (users) of computers can be given the option of reduced warranty costs for participating in data gathering. At block 24, data is collected from all users or, when reduced warranty terms are offered at block 22, from just those who agreed to data gathering. This data includes the operating parameter data from the sensors 16 of preferably plural user computers 14 of the same type or genre. Also, information regarding malfunctions, if any, in the computers 14 that generate the parametric data is recorded. For instance, hard disk drive failure incidents may be noted. If desired, the parametric data and associated malfunction information can be encoded and encrypted for transmission to the analysis computer 12 over the Internet. Or, the information can be prepared for transmission on a “sideband” channel such as a so-called DataFlight Recorder and LAN subsystem using ASF or other schema for security. The information from the user computers may be pushed by the user computers automatically at, e.g., predetermined intervals to the analysis computer 12, or the analysis computer 12 can poll the user computers for their information, which they then send to the analysis computer 12. Any malfunctions are correlated with the information from the user computers.

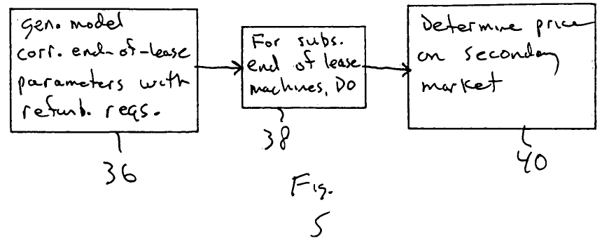

In one non-limiting implementation, the operating parameters can be stored in tables 26 and 28 as respectively shown in FIGS. 3 and 4 for per system and per customer usages. The non-limiting parameters stored in the tables 26 and 28 can include boot count (number of times a computer or computers have been rebooted), actual use (in hours), lifetime temperature (e.g., average), number of temperature alerts due to exceeding a threshold, number of fan alerts, number of times a computer was used for only eight hours per day, and number of times a computer was energized for substantially the entire day.

As shown in the illustrative non-limiting embodiments of FIGS. 3 and 4, three sub-tables can exist in each table, one for excellent usage, one for moderate usage, and one for quality usage (meaning something less optimum than moderate usage). Each parameter can be assigned a different weight in each sub-table using the method discussed further below, to populate the sub-tables with appropriate weights for subsequent use in correlating a customer's actual use to a warranty cost.

At block 30, patterns in the operating parameter information as they relate to malfunctions are noted in a population of computers and used to generate one or more practice profiles, including weighting factors. More specifically, malfunctions of particular user computers 14 are associated with the relevant parametric data from each computer system. The practices profile can be generated using modelling principles known in the art. For example, regression analysis can be used to identify a particular operating parameter value that is correlated with the malfunctions. The analysis to generate the model can be done manually or using neural networks that employ model generation algorithms. In one example, it might happen that a higher than usual number of disk drive failures are discovered to occur at internal disk drive average temperatures exceeding a threshold for a particular period of time. Or, it might be noted that computers operated at temperatures below a threshold experience fewer than expected malfunctions. In any case, the resulting model in such a circumstance can be to generate a profile that assigns a higher weight to temperatures above the threshold and lower weights to those below the threshold.

As another example, it might be observed that a higher than usual number of CPU failures are discovered to occur when average power consumption exceeds a power threshold and when the rate of on-off cycles exceeds a cycle threshold. The resulting model in such a circumstance would be to generate weights for these parameters, e.g., to generate higher weights for average power levels above the power threshold and higher weights for numbers of cycles above the cycle threshold. It might be further noticed that few if any failures are reported for parameters that have values more than 50% below the high thresholds and, hence, such low parameter values would be assigned lower than normal weights. In this way, weights for three (or more) sub-tables as shown in FIGS. 3 and 4 can be generated.

Once the models with weights have been determined, the process subsequently moves to block 32 to compare individual user data (either from individual machines or customer-wide averages for a particular type of machine) with the model. The parameters received are weighted using the weights derived at block 30. In non-limiting implementations each parameter is weighted according to its weight, and the resulting weights are multiplied and/or otherwise aggregated together to arrive at a total weight. The total weight can be correlated to a warranty cost, e.g., total parameter weights below 10 might yield an “excellent” usage rating and concomitantly low warranty cost, total parameter weights between, say, 10 and 20 might yield a “moderate” usage rating and concomitantly medium warranty cost, and total parameter weights above 20 might yield a “quality” rating and a relatively high warranty cost. These prices are established for each individual customer being weighted at block 34.

The above can be provided as a service. For instance, the generated weights can be returned to a vendor server, which can then use the weights to establish warranty costs for various of its customer user computers. Yet again, the profile need not be provided to a vendor, but instead used by a third party server to determine appropriate warranty costs and inform a vendor of the costs it should be charging its customers.

FIG. 5 shows that for leased computers at end of lease, at block 36 a model can be generated that correlates operating parameters to refurbishment requirements. In other words, using the principles above, weights can be generated using a population of end of lease computers for operating parameters as a function of how much refurbishment is required. Once the weights (model) have been generated, for each subsequent end of lease computer at block 38, the process can move to block 40 to determine a price for the computer for resale on the secondary market. For instance, weights indicating that much refurbishment must be done might indicate lower selling prices, while end-of-lease computers not requiring much refurbishment as indicated by the weights associated with their operating parameters might bring higher prices on the secondary market. Or, the reverse could be true. In any case, the operating parameter data can be used to establish prices on the secondary market.

While the particular SYSTEM AND METHOD FOR ESTABLISHING COMPUTER WARRANTY COSTS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A method comprising:
establishing a warranty cost for a user computer at least in part based on operating parameters of the user computer.

2. The method of claim 2, comprising:
using information from plural user computers of a given type, establishing operating parameter weights; and
establishing the user warranty cost at least in part based on the weights.

3. The method of claim 1, wherein the operating parameter is selected from the group of parameters consisting of: temperature, hours of operation, number of on-off cycles, number of temperature alerts, number of fan alerts, power consumption, humidity, voltage, and application factors.

4. A general purpose computer system executing logic comprising:
receiving first data representing at least one computer system operating parameter and associated computer system malfunction;
generating at least one model based on the first data; and
establishing at least one warranty cost at least in part using the model.

5. The system of claim 4, wherein the operating parameter is selected from the group of parameters consisting of: temperature, hours of operation, number of on-off cycles, number of temperature alerts, number of fan alerts, power consumption, humidity, voltage, and application factors.

6. A general purpose computer system comprising:
means for establishing at least one warranty cost for a user computer system based at least in part on operating parameters of the user computer system.

7. The system of claim 6, comprising:
means for using information from plural user computers of a given type to establish operating parameter weights, the means for establishing the user warranty cost using, at least in part, the weights.

8. The system of claim 6, wherein the operating parameter is selected from the group of parameters consisting of: temperature, hours of operation, number of on-off cycles, number of temperature alerts, number of fan alerts, power consumption, humidity, voltage, and application factors.

9. A service, comprising:
providing, to a vendor of computers, warranty costs of user computers as a function of operating parameters of the user computers.

10. The service of claim 9, wherein the operating parameters are selected from the group of parameters consisting of: temperature, hours of operation, number of on-off cycles, power consumption, number of temperature alerts, number of fan alerts, humidity, voltage, and application factors.

11. A method, comprising:
establishing secondary market pricing for computers that are or that have been the subject of leases based at least in part on end of lease operating parameters of the computers.
